(19) United States
(12) Patent Application Publication
(10) Pub. No.: US 2023/0176688 A1
(43) Pub. Date: Jun. 8, 2023

(54) TOUCH SENSING DEVICE, TOUCH DISPLAY DRIVING DEVICE INCLUDING THE SAME AND METHOD OF OPERATING TOUCH DISPLAY DEVICE

(71) Applicant: LX Semicon Co., Ltd., Daejeon (KR)

(72) Inventors: Ji Ho KIM, Daejeon (KR); Hong Kyun JUNG, Daejeon (KR)

(21) Appl. No.: 17/985,629

(22) Filed: Nov. 11, 2022

(30) Foreign Application Priority Data
Dec. 3, 2021 (KR) 10-2021-0171816

(51) Int. Cl. G06F 3/041

(52) U.S. Cl. CPC G06F 3/04166; G06F 3/0412; G06F 3/0418; G06F 2203/04108; G09G 3/20

(57) ABSTRACT

The present disclosure provides a technology for enabling a touch driving signal to have two or more frequencies when the touch driving signal is supplied to a touch electrode that is disposed in a panel.

### CROSS REFERENCE TO RELATED APPLICATION

This application claims priority to the Republic of Korea Patent Application No. 10-2021-0171816, filed on Dec. 3, 2021, which is hereby incorporated by reference in its entirety.

### BACKGROUND

### 1. Field of Technology

The present embodiment relates to a touch sensing technology.

### 2. Related Technology

A technology for recognizing an external object that touches a touch panel or becomes close to the touch panel is called a touch sensing technology. The touch panel is placed on the same location as the display panel on a plane. Accordingly, a user may input a user manipulation signal to the touch panel while watching an image on the display panel. Such a method of generating a user manipulation signal provides excellent user intuitiveness compared to a previous user manipulation signal input method, for example, a mouse input method or a keyboard input method.

Due to such an advantage, the touch sensing technology is applied to various electronic devices including the touch panel. A touch sensing device may supply a touch driving signal to a driving electrode that is disposed in the touch panel, and may sense the touch or proximity of an external object for the touch panel by receiving a touch response signal that is formed in a sensing electrode.

If the touch sensing device supplies a touch driving signal having a constant frequency to the touch panel side, the density of a corresponding frequency spectrum may be increased. This may cause electromagnetic interference (hereinafter referred to as “EMI”).

The discussions in this section are only to provide background information and do not constitute an admission of prior art.

### SUMMARY

In such a background, the present embodiment is to provide a touch sensing technology for reducing EMI through a touch driving signal, that is, a signal in which the pulses of at least two frequencies alternate.

An embodiment provides a touch sensing device, including a driving circuit configured to supply a touch driving signal to a touch electrode disposed in a panel and a sensing circuit configured to sense the touch or proximity of an external object for the panel in response to a touch response signal that is formed in the touch electrode in accordance with the touch driving signal, wherein the touch driving signal supplied for one touch sensing period in which a touch synchronization signal maintains a first level includes a signal in which the pulses of different frequencies alternate.

Another embodiment provides a touch display device, including multiple touch electrodes disposed inside or outside a panel and a touch sensing device including a driving circuit configured to supply a touch driving signal to at least one of the multiple touch electrodes and a sensing circuit configured to sense the touch or proximity of an external object for the panel in response to a touch response signal that is formed in a touch electrode in accordance with the touch driving signal, wherein the touch driving signal supplied for one touch sensing period in which a touch synchronization signal maintains a first level is a signal in which the pulses of at least two frequencies alternate.

Still another embodiment provides a method of operating a touch display device, comprising: generating a touch driving signal including a signal in which the pulses of at least two frequencies alternatively appear; supplying a touch driving signal to a touch electrode disposed in a panel for one touch sensing period; and sensing the touch or proximity of an external object for the panel in response to a touch response signal that is formed in a touch electrode in accordance with the touch driving signal

Still another embodiment provides a device for driving a touch display, including a data driving device configured to drive pixels disposed in a panel for a display period in which a touch synchronization signal maintains a second level and a touch sensing device configured to supply a touch driving signal to at least one of multiple touch electrodes disposed in the panel for a touch sensing period in which the touch synchronization signal maintains a first level and to sense the touch or proximity of an external object for the panel in response to a touch response signal that is formed in a touch electrode in accordance with the touch driving signal, wherein the touch driving signal supplied for one touch sensing period includes a signal in which the pulses of different frequencies alternate.

The touch driving signal may be a signal in which the pulse of a first frequency and the pulse of a second frequency alternate for a first period of the one touch sensing period and a signal in which the pulse of a third frequency and the pulse of a fourth frequency alternate for a second period of the one touch sensing period, which is different from the first period, the first frequency and the second frequency may be different frequencies, and the third frequency and the fourth frequency may be different frequencies.

The touch driving signal may be a signal in which the pulse of a first frequency and the pulse of a second frequency alternate for a first period included in a first touch sensing period and a signal in which the pulse of a third frequency and the pulse of a fourth frequency alternate for a second period included in a second touch sensing period different from the first touch sensing period, and the first frequency and the third frequency may be different frequencies.

As described above, the present embodiments can provide the touch sensing device for reducing EMI through a touch driving signal, that is, a signal in which the pulses of at least two frequencies alternate, the touch display device including the touch sensing device, and the method of operating the touch display device.

### BRIEF DESCRIPTION OF THE DRAWINGS

FIG. 1 is a construction diagram of a touch display device according to the present embodiments.

FIG. 2 is a diagram illustrating the touch sensing device and a panel illustrated in FIG. 1.

FIG. 3 is a construction diagram of the touch sensing device of FIG. 2.

FIG. 4 is a diagram illustrating waveforms of a synchronization signal, touch driving signal, and auxiliary signal of the touch display device illustrated in FIG. 1.

FIG. 5 is a diagram illustrating a touch synchronization signal, a touch driving signal, and the frequency of the touch driving signal in FIG. 3.

FIG. 6 is a diagram illustrating an example of the touch driving signal in FIG. 3.

FIG. 7 is an example illustrating a touch driving signal for one touch sensing period in FIG. 6.

FIG. 8 is a diagram illustrating a touch driving signal for two different touch sensing periods in FIG. 6.

FIG. 9 is a diagram illustrating the touch sensing device illustrated in FIG. 3 and multiple touch electrodes connected to the touch sensing device.

FIG. 10 is a diagram illustrating an example of a touch driving signal that is output through a MUX circuit for one touch sensing period in FIG. 9.

FIG. 11 is a diagram illustrating another example of a touch driving signal that is output through the MUX circuit for one touch sensing period in FIG. 9.

FIG. 12 is a diagram illustrating still another example of a touch driving signal that is output through the MUX circuit for one touch sensing period in FIG. 9.

FIG. 13 is a diagram illustrating a touch driving signal and an auxiliary signal in the touch display device illustrated in FIG. 1.

FIG. 14 is a diagram illustrating a method of operating the touch display device illustrated in FIG. 1.

### DETAILED DESCRIPTION OF EMBODIMENTS

Hereinafter, the present embodiments are described in detail with reference to exemplary drawings.

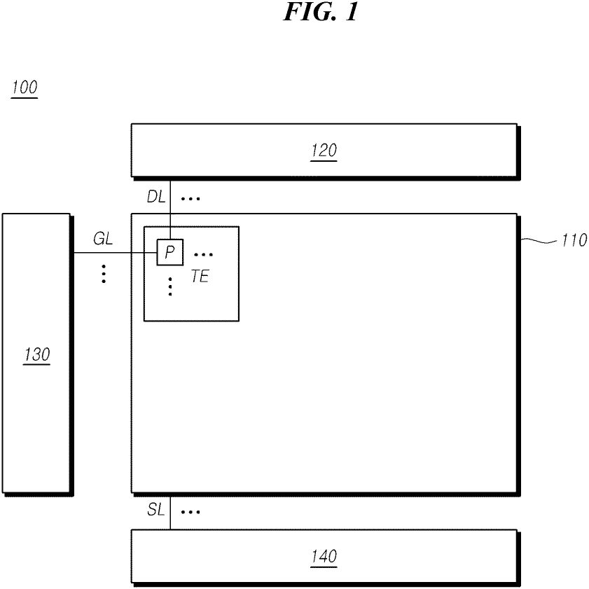

FIG. 1 is a construction diagram of a touch display device according to embodiments of the present disclosure.

Referring to FIG. 1, the touch display device 100 may include a panel 110, a data driving device 120, a gate driving device 130, a touch sensing device 140, etc.

Multiple data lines DL connected to the data driving device 120 may be formed in the panel 110. Multiple gate lines GL connected to the gate driving device 130 may be formed in the panel 110. Furthermore, multiple pixels P corresponding to points at which the multiple data lines DL and the multiple gate lines GL intersect may be defined in the panel 110.

A transistor whose first electrode (e.g., a source electrode or a drain electrode) is connected to the data line DL, whose gate electrode is connected to the gate line GL, and whose second electrode (e.g., a drain electrode or a source electrode) is connected to a display electrode may be formed in each pixel P.

Furthermore, multiple touch electrodes TE may be spaced apart from each other and formed in the panel 110. One pixel P or multiple pixels P may be disposed in an area in which the touch electrode TE is disposed.

The panel 110 may include a display panel and a touch panel. In this case, the display panel and the touch panel may share their some components. For example, the multiple touch electrodes TE may be one component (e.g., a common electrode that applies a common voltage) of the display panel, and may also be one component (e.g., a touch electrode for detecting a touch) of the touch panel. From an aspect that some components of the display panel and the touch panel may be shared, such a panel 110 is also called an integrated panel. However, the present embodiment is not limited thereto. Furthermore, an in-cell type panel is known as a form in which some components of the display panel and the touch panel are shared, but this corresponds to an embodiment of the panel 110. The panel 110 to which the present embodiment is applied is not limited to the in-cell type panel.

The data driving device 120 supplies a data signal to the data line DL for displaying an image in each pixel P of the panel 110.

The data driving device 120 may include at least one data driver integrated circuit. The data driver integrated circuit may be connected to a bonding pad of the panel 110 by using a tape automated bonding (TAB) method or a chip on glass (COG) method or may be directly formed on the panel 110. In some cases, the data driver integrated circuit may be integrated and formed on the panel 110. Furthermore, the data driving device 120 may be implemented by using a chip on film (COF) method.

The gate driving device 130 sequentially supplies scan signals to the gate lines GL in order to turn on or off the transistors disposed in the pixels P.

The gate driving device 130 may be disposed on only one side of the panel 110 as illustrated in this drawing or may be divided into two and disposed on both sides of the panel 110, depending on a driving method.

Furthermore, the gate driving device 130 may include at least one gate driver integrated circuit. In this case, the gate driver integrated circuit may be connected to a bonding pad of the panel 110 by using the TAB method or the COG method or may be implemented in a gate in panel (GIP) type and may be directly formed on the panel 110. In some cases, the gate driver integrated circuit may be integrated and formed on the panel 110. Furthermore, the gate driving device 130 may be implemented by using the COF method.

The touch sensing device 130 supplies a touch driving signal to some or all of multiple touch electrodes TE connected to the sensing line SL.

The touch sensing device 140 may be disposed outside the data driving device 120 and the gate driving device 130 as illustrated in FIG. 1. However, the touch sensing device 140 may be implemented as an internal component of another separate driver integrated circuit that includes at least one of the data driving device 120 and the gate driving device 130 or may be implemented as an internal component of the data driving device 120 or the gate driving device 130 depending on an implementation method.

Accordingly, if the touch sensing device 140 supplies the touch driving signal to some or all of the multiple touch electrodes TE, this may be considered that a separate driver integrated circuit including the touch sensing device 140 supplies the touch driving signal to some or all of the multiple touch electrodes TE. Furthermore, this may be considered that the data driving device 120 or the gate driving device 130 including the touch sensing device 140 supplies the touch driving signal to some or all of the multiple touch electrodes TE depending on a design method.

The touch sensing device 140 is not limited to an implementation and design method, and may be another component itself or may be a component disposed inside or outside another component if only a function that is described in this specification and performed by the touch sensing device 140 is the same or similar.

Furthermore, in FIG. 1, one touch sensing device 140 has been illustrated as being disposed in the touch display device 100, but the touch display device 100 may include two or more touch sensing devices 140.

In order for the touch sensing device 140 to supply a touch driving signal to some or all of the multiple touch electrodes TE, there is a need for the sensing line SL that is connected to each of the multiple touch electrodes TE. Accordingly, the sensing line SL that is connected to each of the multiple touch electrodes TE and that transfers a driving signal may be formed in the panel 110 in a first direction (e.g., a longitudinal direction) or a second direction (e.g., a transverse direction).

The touch display device 100 may adopt a capacitive type touch method of recognizing the touch or proximity for an external object by sensing a change in capacitance through the touch electrode TE.

The capacitive type touch method may be divided into a mutual capacitance touch method and a self-capacitance touch method, for example.

In the mutual capacitance touch method, that is, one type of the capacitive type touch method, a touch driving signal of one touch electrode (Tx electrode) is supplied. Another touch electrode (Rx electrode) mutually coupled with the Tx electrode is sensed. In the mutual capacitance touch method, a value that is sensed in the Rx electrode is different depending on the touch or proximity of an external object, such as a finger or a pen. In the mutual capacitance touch method, whether a touch is present or touch coordinates are detected by using the sensing value in the Rx electrode.

In the self-capacitance touch method, that is, another type of the capacitive type touch method, after a touch driving signal is supplied to one touch electrode TE, the touch electrode TE is sensed again. In the self-capacitance touch method, a value that is sensed in a corresponding touch electrode TE is different depending on the touch or proximity of an external object, such as a finger or a pen. In the self-capacitance touch method, whether a touch is present or touch coordinates are detected by using the sensing value. In the self-capacitance touch method, there is no distinction between a Tx electrode and an Rx electrode because a touch electrode TE to which a touch driving signal is supplied and a touch electrode TE that is sensed are the same.

The touch display device 100 may adopt one of the two capacitive type touch methods (i.e., the mutual capacitance touch method and the self-capacitance touch method). However, in this specification, embodiments are described assuming that the self-capacitance touch method has been adopted for convenience of description.

The touch display device 100 may drive the touch electrode TE by distinguishing between a display period and a touch sensing period. For example, the touch sensing device 140 of the touch display device 100 may not supply a touch driving signal to some or all of the touch electrodes TE in the period in which a data signal is supplied.

Furthermore, the touch display device 100 may drive the touch electrode TE without distinguishing between the display period and the touch sensing period. For example, the touch sensing device 140 of the touch display device 100 may supply a touch driving signal to some or all of the touch electrodes TE in the period in which a data signal is supplied.

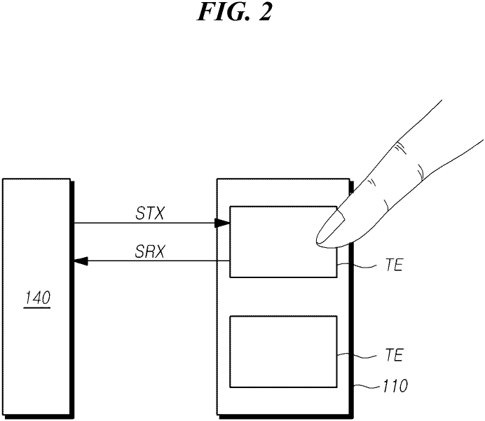

FIG. 2 is a diagram illustrating the touch sensing device and the panel illustrated in FIG. 1.

Referring to FIG. 2, the touch sensing device 140 may supply a touch driving signal STX to the touch electrode TE disposed in the panel.

The touch driving signal STX may be a signal having a voltage or a current. The touch driving signal STX having a voltage form may be defined as a driving voltage. The driving signal STX may be a pulse type. Furthermore, the touch driving signal STX may be various forms of waveforms including a sinusoidal waveform and a rectangular waveform. However, in this specification, embodiments are described assuming that the touch driving signal STX having the rectangular waveform has been adopted for convenience of description.

The touch sensing device 140 may receive a response signal SRX for the driving signal STX from the touch electrode TE, and may sense the touch or proximity of an external object for the panel 110 by demodulating the response signal SRX. The response signal SRX may be a signal having a current or voltage form.

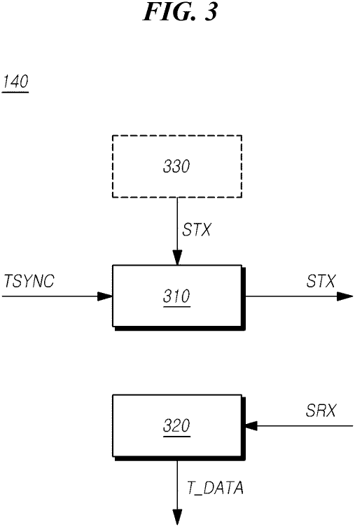

FIG. 3 is a construction diagram of the touch sensing device of FIG. 2.

Referring to FIG. 3, the touch sensing device 140 may include a driving circuit 310 and a sensing circuit 320.

The driving circuit 310 may supply the touch driving signal STX to the touch electrode TE disposed in the panel 110.

The sensing circuit 320 may sense the touch or proximity of the external object for the panel in response to the touch response signal SRX that is formed in the touch electrode TE corresponding to the touch driving signal STX. The sensing circuit 320 may generate sensing data T_DATA in response to the touch response signal SRX.

The sensing data T_DATA may include a sensing value that is demodulated and generated from the touch response signal SRX. The sensing value may be a time integral value of a current or voltage of the response signal SRX, for example. The sensing value may be used to determine whether a touch of the external object for the panel 110 is present or to generate touch coordinates of the touch. For example, when the size of the sensing value is greater than or smaller than a reference value, it may be determined that the touch of an object has occurred.

The signal generating circuit 330 may generate the touch driving signal STX that is supplied to the touch electrode TE disposed in the panel 110. The driving circuit 310 may receive the touch driving signal STX that is generated by a signal generating circuit 330.

The signal generating circuit 330 may be disposed within the touch sensing device 140, but may be present within the data driving device 120 or the gate driving device 130. The signal generating circuit 330 may be implemented through a separate integrated circuit depending on an implementation method thereof.

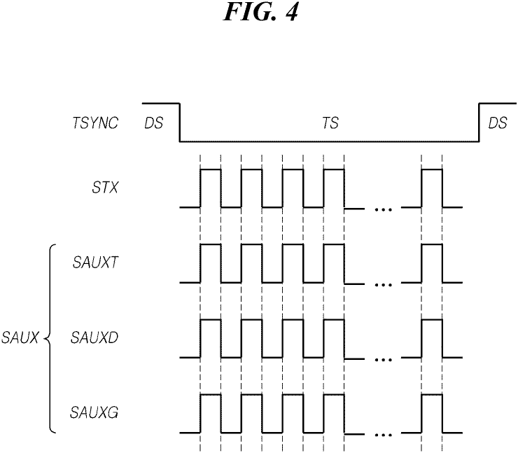

FIG. 4 is a diagram illustrating waveforms of a synchronization signal, touch driving signal, and auxiliary signal of the touch display device illustrated in FIG. 1.

Referring to FIG. 4, the signal generating circuit 330 may generate a touch driving signal STX and an auxiliary signal SAUX corresponding to the touch driving signal STX.

In this case, the auxiliary signal SAUX may be supplied to one or more electrodes disposed in the panel 110.

For a touch sensing period TS, when the touch driving signal STX is supplied to the touch electrode TE of the panel 110, the touch electrode TE to which the touch driving signal STX is supplied may form parasitic capacitance along with the data line DL, the gate line GL, and another touch electrode TE.

For the touch sensing period TS, touch sensing accuracy may be reduced because noise attributable to the parasitic capacitance may be introduced.

At this time, when at least one of the multiple touch electrodes TE disposed in the panel 110 is driven for the touch sensing period TS, the signal generating circuit 230 may generate an auxiliary signal SAUXT that will be supplied to another touch electrode TE in which parasitic capacitance may be formed, an auxiliary signal SAUXD to be supplied to the data line, and an auxiliary signal SAUXG to be supplied to the gate line.

In this case, the auxiliary signal SAUX may have substantially the same phase the touch driving signal STX.

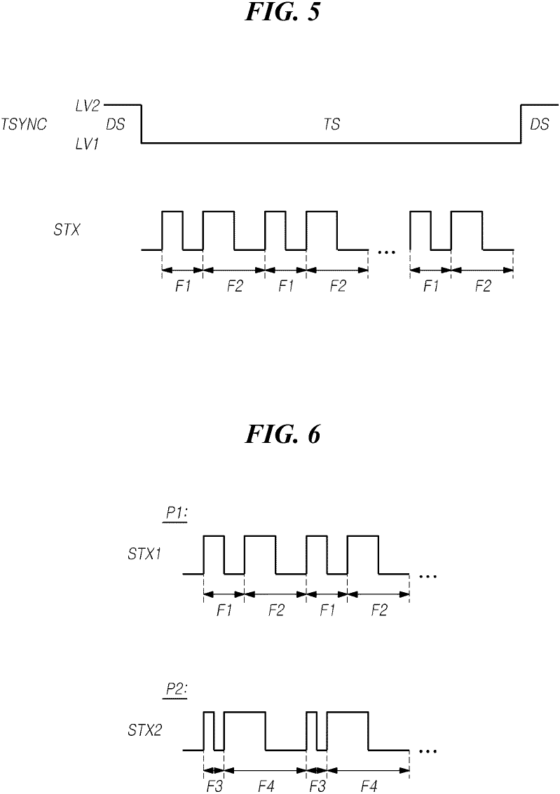

FIG. 5 is a diagram illustrating a touch synchronization signal, a touch driving signal, and the frequency of the touch driving signal in FIG. 3.

Referring to FIG. 5, the touch driving signal STX that is supplied for one touch sensing period TS in which a touch synchronization signal TSYNC maintains a first level LV1 may be a signal in which the pulses of at least two frequencies F1 and F2 alternate.

As described above, the touch display device 100 may drive the touch electrode TE by distinguishing between a display period DS and a touch sensing period TS. The period in which the touch synchronization signal TSYNC has the first level LV1 may correspond to the touch sensing period TS. The period in which the touch synchronization signal TSYNC has a second level LV2 may correspond to the display period DS. In this case, the first level LV1 may be a low level, and the second level LV2 may be a high level. The first level LV1 may be a high level and the second level LV2 may be a low level depending on an implementation method. A case in which the first level LV1 is a low level and the second level LV2 is a high level is described.

In FIG. 5, the touch synchronization signal TSYNC first has the second level LV2, and this corresponds to the display period DS. For the display period DS, a data signal is supplied to the panel. After the display period DS is ended, the level of the touch synchronization signal TSYNC is changed into the first level LV1. This corresponds to the touch sensing period TS. The driving circuit 310 may supply the touch driving signal STX to the touch electrode TE disposed in the panel for the touch sensing period TS.

If the touch driving signal STX that is supplied from the driving circuit 310 of the touch sensing device 140 to the touch electrode TE is set as one frequency, there is a problem in that EMI occurs because the density of a corresponding frequency spectrum is high. The EMI occurred by the touch driving signal STX may hinder an image from being displayed on the touch display device 100 or may cause performance degradation of the touch display device 100 by causing a malfunction in the touch display device 100.

The driving circuit 330 may use at least two frequencies F1 and F2 without transmitting the touch driving signal STX using a single frequency to the touch electrode TE, as measures for reducing EMI occurred by the touch driving signal STX. In this case, the touch driving signal STX may be a signal in which the pulses of the at least two frequencies F1 and F2 alternate.

In FIG. 5, the touch driving signal STX may be a signal in which the pulse of the first frequency F1 and the pulse of the second frequency F2 different from the first frequency alternate. Assuming that the touch driving signal STX is a signal in which the pulse of the first frequency F1 is repeated, the density of a frequency spectrum in the area of the touch driving signal STX that corresponds to the first frequency F1 may be high. If the touch driving signal STX is a signal in which the pulse of the first frequency F1 and the pulse of the second frequency F2 alternate, the density of a frequency spectrum in the area of the touch driving signal STX may be low compared to a single frequency because the density is distributed to the first frequency F1 and the second frequency F2. If the signal in which the pulse of the first frequency F1 and the pulse of the second frequency F2 alternate is supplied to the touch electrode TE, EMI occurred by the touch driving signal STX can be reduced, and noise occurring due to EMI can be reduced or a malfunction of the touch display device 100 can be prevented.

Unlike in the case illustrated in FIG. 5, the touch driving signal STX may be a signal in which the pulses of three or more frequencies are additionally added and alternate, in addition to the pulses of the two frequencies F1 and F2. The order that the pulses of the touch driving signals STX alternate may be variously changed.

FIG. 6 is a diagram illustrating an example of the touch driving signal in FIG. 3.

Referring to FIG. 6, for a first period P1, a first touch driving signal STX1 may be a signal in which the pulse of a first frequency F1 and the pulse of a second frequency F2 alternate. For a second period P2, a second touch driving signal STX2 may be a signal in which the pulse of a third frequency F3 and the pulse of a fourth frequency F4 alternate.

In order to drive the touch electrode TE, the driving circuit 310 may supply the touch electrode TE with a touch driving signal STX in which the pulse of the first frequency F1 to the pulse of the fourth frequency F4 alternate. The density of a frequency spectrum in the area of the touch driving signal STX may be distributed to the first frequency F1 to the fourth frequency F4, so that EMI can be reduced. In this case, however, the type of frequency having a pulse that alternates once is four.

The driving circuit 310 of the touch sensing device 140 may supply the touch electrode TE with the first touch driving signal STX1, that is, the signal in which the pulse of the first frequency F1 and the pulse of the second frequency F2 alternate, for the first period P1, and may supply the touch electrode TE with the second touch driving signal STX2, that is, the signal in which the pulse of the third frequency F3 and the pulse of the fourth frequency F4 alternate, for the second period P2 different from the first period P1. In this case, the type of frequency having a pulse that alternates in each of the first period P1 and the second period P2 is two.

As described above, the touch driving signal STX2 may be generated by the signal generating circuit 330. It may be easy in terms of an implementation method of the signal generating circuit 330 when the signal generating circuit 330 generates each of the first touch driving signal STX1 and the second touch driving signal STX2 in each of which the pulses of two frequencies alternate, rather than generating the touch driving signal STX in which the pulses of four frequencies alternate for one period.

Accordingly, the signal generating circuit 330 can generate the touch driving signal STX by using a relatively easy method. Accordingly, the density of a frequency spectrum in the area of the touch driving signal STX can be distributed to the first frequency F1 to the fourth frequency F4.

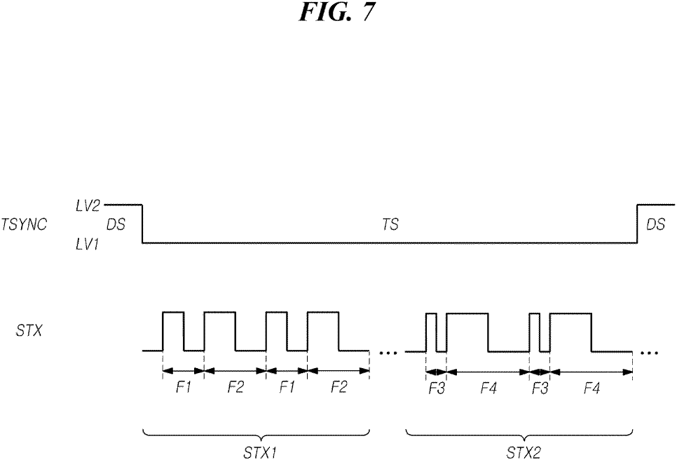

FIG. 7 is an example illustrating a touch driving signal for one touch sensing period in FIG. 6.

Referring to FIG. 7, a first period P1 and a second period P2 may be included in one touch sensing period TS.

In this case, a touch driving signal STX is a signal in which the pulse of the first frequency F1 and the pulse of the second frequency F2 alternate for the first period P1 of the one touch sensing period TS and is a signal in which the pulse of the third frequency F3 and the pulse of the fourth frequency F4 alternate for the second period P2 of the one touch sensing period TS, which is different from the first period P1.

A touch synchronization signal TSYNC first maintains a second level LV2. The second level LV2 corresponds to a display period DS. For the display period DS, a data signal is supplied to the display panel. Thereafter, the level of the touch synchronization signal TSYNC is changed into a first level LV1, and the touch sensing period TS is started.

As illustrated in FIG. 7, the first period P1 included in the touch sensing period TS is started simultaneously with the start of the touch sensing period TS. The touch driving signal STX may be a first touch driving signal STX1, that is, a signal in which the pulse of the first frequency F1 and the pulse of the second frequency F2 alternate for the first period P1.

After the first period P1 of the one touch sensing period TS is ended, the second period P2 is started. The touch driving signal STX may be a second touch driving signal STX2, that is, a signal in which the pulse of the third frequency F3 and the pulse of the fourth frequency F4 alternate for the second period P2.

Accordingly, for the one touch sensing period TS, the touch electrode TE may be supplied with the first touch driving signal STX1, that is, the signal in which the pulse of the first frequency F1 and the pulse of the second frequency F2 alternate, and the second touch driving signal STX2, that is, the signal in which the pulse of the third frequency F3 and the pulse of the fourth frequency F4 alternate. In this case, if at least four types of frequencies are used, the density of a frequency spectrum in the area of the touch driving signal STX can be reduced compared to a case in which one frequency is used. Accordingly, a malfunction of the touch display device 100 can be prevented and noise can be reduced because EMI attributable to the touch driving signal STX is reduced.

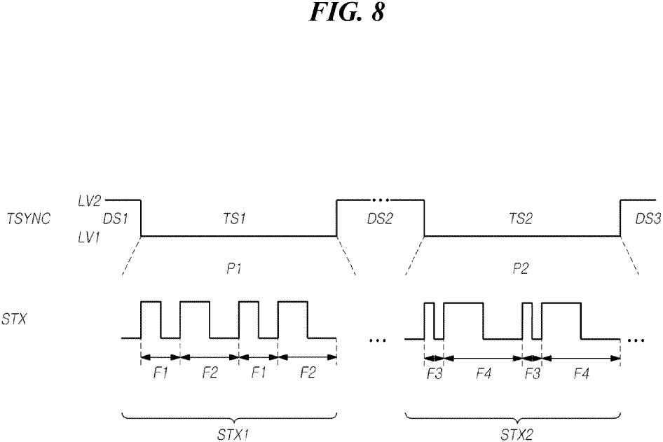

FIG. 8 is a diagram illustrating a touch driving signal for two different touch sensing periods in FIG. 6.

Referring to FIG. 8, the first period P1 may be included in a first touch sensing period TS1. The second period P2 may be included in a second touch sensing period TS2 different from the first touch sensing period TS1.

In this case, a touch driving signal STX is a signal in which the pulse of the first frequency F1 and the pulse of the second frequency F2 alternate for the first period P1 included in the first touch sensing period TS1 and is a signal in which the pulse of the third frequency F3 and the pulse of the fourth frequency F4 alternate for the second period P2 included in the second touch sensing period TS2 different from the first touch sensing period TS1.

A touch synchronization signal TSYNC first maintains a second level LV2. The second level LV2 corresponds to a first display period DS1, and a data signal is supplied to the display panel. Thereafter, the level of the touch synchronization signal TSYNC is changed into a first level LV1, so that the first touch sensing period TS1 is started.

As illustrated in FIG. 8, the first period P1 included in the first touch sensing period TS1 may be started simultaneously with the start of the first touch sensing period TS1. The touch driving signal STX may be a first touch driving signal STX1, that is, a signal in which the pulse of the first frequency F1 and the pulse of the second frequency F2 alternate for the first period P1.

Thereafter, after the first touch sensing period TS1 is terminated, the level of the touch synchronization signal TSYNC may be changed into the second level, so that a second display period DS2 may be started.

After the second display period DS2 is terminated, the level of the touch synchronization signal TSYNC may be changed into the first level again, so that the second touch sensing period TS2 may be started.

The second period P2 included in the second touch sensing period TS2 may be started simultaneously with the start of the second touch sensing period TS2. The touch driving signal STX may be a second touch driving signal STX2, that is, a signal in which the pulse of the third frequency F3 and the pulse of the fourth frequency F4 alternate for the second period P2.

As illustrated in FIG. 8, the second touch sensing period TS2 may be a touch sensing period TS subsequent to the end of the first touch sensing period TS1. In contrast, differently from the case of FIG. 8, another touch sensing period TS may be disposed between the second touch sensing period TS2 and the first touch sensing period TS1, so that the second touch sensing period TS2 may not be subsequent to the first touch sensing period TS1.

Accordingly, the density of a frequency spectrum in the area of the touch driving signal STX can be reduced, and image noise attributable to EMI and a touch obstacle can be reduced because the four types of frequencies are used for the first touch sensing period TS1 and the second touch sensing period TS2.

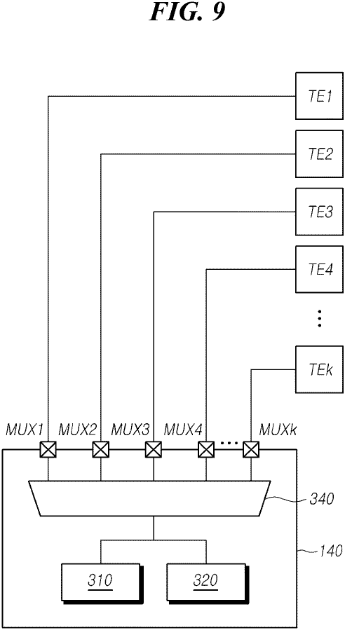

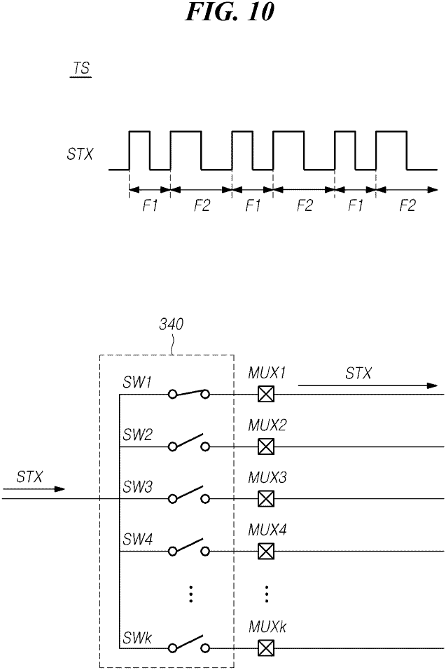

FIG. 9 is a diagram illustrating the touch sensing device in FIG. 3 and multiple touch electrodes connected to the touch sensing device.

Referring to FIG. 9, the touch sensing device 140 may further include a MUX circuit 340 for selectively outputting a touch driving signal STX to at least one of multiple output terminals MUX1, MUX2, MUX3, MUX4 to MUXk.

The multiple output terminals MUX1, MUX2, MUX3, MUX4 to MUXk may be electrically connected to touch electrodes TE1, TE2, TE3, TE4 to TEk, respectively.

The MUX circuit 340 may receive a touch response signal SRX from the touch electrode TE to which the touch driving signal STX is supplied, and may transfer the touch response signal SRX to the sensing circuit 320.

The MUX circuit 340 may be connected to the touch electrode TE in one row (or one column), which is disposed in one direction (e.g., a longitudinal direction) of the panel 110. The touch sensing device 140 may supply the touch driving signal STX to the multiple touch electrodes TE1, TE2, TE3, TE4 to TEk through the MUX circuit 340.

The MUX circuit 340 may operate in a multi-MUX mode in which the MUX circuit 340 outputs the touch driving signal STX to two or more output terminals (e.g., MUX1 and MUX2) for one touch sensing period TS or may operate in a single MUX mode in which the MUX circuit 340 outputs the touch driving signal STX to one output terminal (e.g., MUX1) for one touch sensing period TS.

The MUX circuit 340 may be disposed in a separate integrated circuit outside the panel 110 or may be disposed in the panel 110 depending on an implementation method thereof.

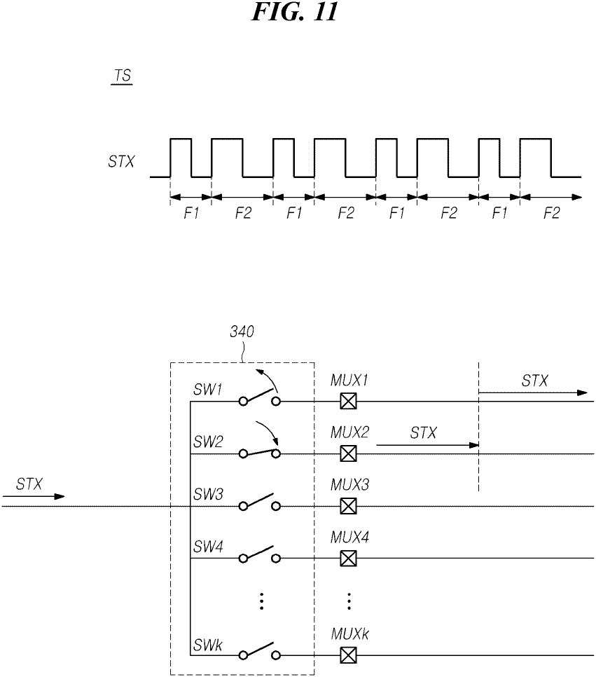

FIG. 10 is a diagram illustrating an example of a touch driving signal that is output through the MUX circuit for one touch sensing period in FIG. 9.

Referring to FIGS. 9 and 10, the touch sensing device 140 may output a touch driving signal STX to one output terminal (e.g., MUX1) for one touch sensing period TS.

The MUX circuit 340 may include multiple switches SW1, SW2, SW3, SW4 to SWk corresponding to the multiple output terminals MUX1, MUX2, MUX3, MUX4 to MUXk, respectively. Each of the multiple switches SW1, SW2, SW3, SW4 to SWk may be turned on or off, and may select the output terminal MUX1 to which the touch driving signal STX will be output.

The MUX circuit 340 of the touch sensing device 140 in FIG. 10 may supply the touch driving signal STX to one touch electrode TE1 for one touch sensing period TS. In this case, the MUX circuit 340 may turn on the switch SW1 and turn off other switches SW2, SW3, SW4 to SWk in order to output the touch driving signal STX through the output terminal MUX1 corresponding to the touch electrode TE1.

In a conventional technology, in order to reduce EMI attributable to a touch driving signal STX, in the multi-MUX mode, multiple output terminals (e.g., MUX1 and MUX2) output touch driving signals STX that have constant and different frequencies for one touch sensing period TS. However, such a method has limitations in reducing EMI in a single MUX mode because a touch driving signal STX having one type of frequency is output to one output terminal (e.g., MUX1) for one touch sensing period TS.

As illustrated in FIG. 10, a touch driving signal STX may be a signal in which the pulse of a first frequency F1 and the pulse of a second frequency F2 alternate. The MUX circuit 340 may output, to one output terminal MUX1, the touch driving signal STX having the two frequencies F1 and F2 for one touch sensing period TS.

Accordingly, even when the MUX circuit 340 operates in the single MUX mode, the density of a frequency spectrum in the area of the touch driving signal STX can be relatively reduced compared to the conventional technology because the density is distributed to the first frequency F1 and the second frequency F2. Accordingly, EMI can be reduced.

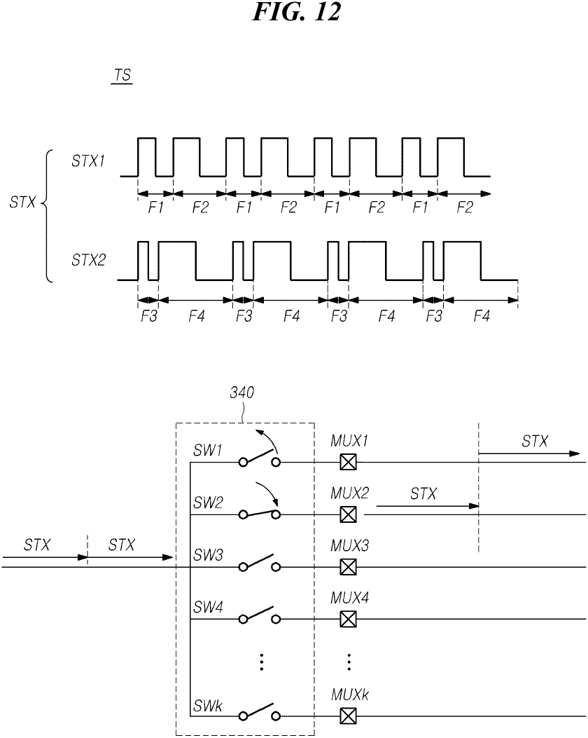

FIG. 11 is a diagram illustrating another example of a touch driving signal that is output through the MUX circuit for one touch sensing period in FIG. 9.

Referring to FIGS. 9 and 11, the MUX circuit 340 may output a touch driving signal STX to at least two output terminals (e.g., MUX1 and MUX2) for one touch sensing period TS.

As described above, the MUX circuit 340 may operate in the multi-MUX mode. In this case, in order to output the touch driving signal STX to two or more output terminals MUX1 and MUX2, the one touch sensing period TS may be time-divided by the number of output terminals MUX1 and MUX2 to which the touch driving signal STX will be output. For example, the one touch sensing period TS may be divided into a first output period in which a touch driving signal is output to the first output terminal MUX1 and a second output period in which a touch driving signal STX is output to the second output terminal MUX2.

In order to output the touch driving signal STX to the first output terminal MUX1 for the first output period, only the switch SW1 among switches included in the MUX circuit 340 is turned on, and the states of the remaining switches SW2, SW3, SW4 to SWk are a turn-off state. After the first output period is ended, for the second output period in which the touch driving signal STX is output to the second output terminal MUX2, the switch SW1 that has been previously turned on is turned off, and the switch SW2 is turned on. For the one touch sensing period TS, the touch driving signal STX may be sequentially output to the first output terminal MUX1 and the second output terminal MUX2 and supplied to the touch electrode TE1 and the touch electrode TE2. In this case, the touch driving signal STX may be a signal in which the pulse of a first frequency F1 and the pulse of a second frequency F2 alternate.

The aforementioned example merely describes that the touch driving signal STX is output to the two output terminals MUX1 and MUX2 for the one touch sensing period TS. The MUX circuit 340 is not limited to the example, and may also output the touch driving signal STX to three or more output terminals (e.g., MUX1, MUX2, and MUX3) for the one touch sensing period TS.

The MUX circuit 340 may operate in the multi-MUX mode and supply the touch driving signal STX to at least two touch electrodes TE1 and TE2 for the one touch sensing period TS. Furthermore, the density of a frequency spectrum in the area of the touch driving signal STX may be relatively reduced because the density is distributed to the first frequency F1 and the second frequency F2. Accordingly, EMI occurring due to the touch driving signal STX can be reduced.

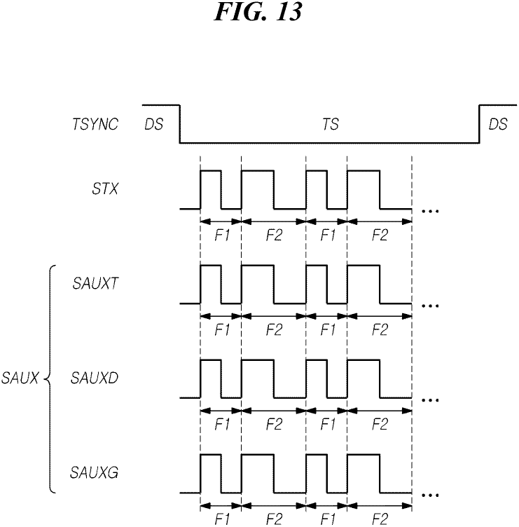

FIG. 12 is a diagram illustrating still another example of a touch driving signal that is output through the MUX circuit for one touch sensing period in FIG. 9.

Referring to FIGS. 9 and 12, a touch driving signal STX1 that is output to the first output terminal MUX1 of at least two output terminals MUX1 and MUX2 for one touch sensing period TS may be a signal in which the pulse of a first frequency F1 and the pulse of a second frequency F2 alternate. A touch driving signal STX2 that is output to the second output terminal MUX2 of the at least two output terminals MUX1 and MUX2 for the one touch sensing period TS may be a signal in which the pulse of a third frequency F3 and the pulse of a fourth frequency F4 alternate.

As described above, the MUX circuit 340 may operate in the multi-MUX mode.

The MUX circuit 340 may sequentially receive, from the driving circuit 310, the first touch driving signal STX1, that is, the signal in which the pulse of the first frequency F1 and the pulse of the second frequency F2 alternate, and the second touch driving signal STX2, that is, the signal in which the pulse of the third frequency F3 and the pulse of the fourth frequency F4 alternate. The MUX circuit 340 may output the first touch driving signal STX1 to the first output terminal MUX1 because only the switch SW1 is turned on for the period in which the first touch driving signal STX1 is received. The first touch driving signal STX1 may be supplied to the touch electrode TE1 through the first output terminal MUX1.

After receiving the first touch driving signal STX1 from the driving circuit 310, the MUX circuit 340 may receive the second touch driving signal STX2. While the second touch driving signal STX2 is received, the MUX circuit 340 may turn off the switch SW1, may turn on only the switch SW2, and may output the second touch driving signal STX2 to the second output terminal MUX2. The second touch driving signal STX2 may be supplied to the touch electrode TE2 through the second output terminal MUX2.

In this case, if the first touch driving signal STX1 is supplied to the touch electrode TE1 through the first output terminal MUX1 and the second touch driving signal STX2 is supplied to the touch electrode TE2 through the second output terminal MUX1, the density of a frequency spectrum in the area of the touch driving signal STX can be reduced because the density is distributed to the first frequency F1 to the fourth frequency F4. EMI can be more effectively reduced if only any one of the first touch driving signal STX1 or the second touch driving signal STX2 is supplied to the first output terminal MUX1 and the second output terminal MUX2.

The touch display device 100 may further include the signal generating circuit 330 for generating a touch driving signal STX and an auxiliary signal SAUX corresponding to the touch driving signal.

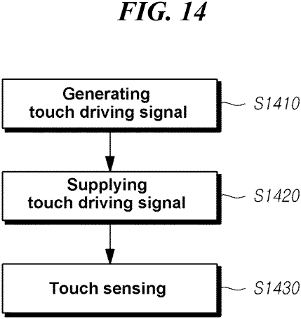

FIG. 13 is a diagram illustrating a touch driving signal and an auxiliary signal in the touch display device illustrated in FIG. 1.

Referring to FIG. 13, the frequency of an auxiliary signal SAUX may be changed in synchronization with the frequency of a touch driving signal STX.

As described above, the touch electrode TE may form parasitic capacitance along with surrounding electrodes (e.g., a gate line, a data line or another touch electrode) thereof. The parasitic capacitance may become an obstacle in sensing the touch or proximity of the external object 10.

The auxiliary signal SAUX that is generated by the signal generating circuit 330 may be supplied to surrounding electrodes of the touch electrode TE. In this case, if the auxiliary signal SAUX has the same phase as the touch driving signal STX, touch sensing performance of the touch display device 100 may be increased because parasitic capacitance is effectively reduced.

FIG. 13 illustrates a first auxiliary signal SAUXT supplied to another touch electrode TE that forms parasitic capacitance along with the touch electrode TE to which the touch driving signal STX is supplied, a second auxiliary signal SAUXD supplied to the data line DL, and a third auxiliary signal SAUXG supplied to the gate line GL.

In this case, the touch driving signal STX is a signal in which the pulse of a first frequency F1 and the pulse of a second frequency F2 alternate. The first auxiliary signal SAUXT, the second auxiliary signal SAUXD, and the third auxiliary signal SAUXG may have the same phase in synchronization with the touch driving signal STX. Furthermore, each of the first auxiliary signal SAUXT, the second auxiliary signal SAUXD, and the third auxiliary signal SAUXG may be a signal in which the pulse of the first frequency F1 and the pulse of the second frequency F2 alternate in synchronization with the frequency of the touch driving signal STX.

In FIG. 13, the auxiliary signal SAUX may be supplied to at least one of multiple electrodes that are disposed in the panel except the touch electrode TE to which the touch driving signal STX is supplied, for one touch sensing period TS.

For example, the first auxiliary signal SAUXT may be generated by the signal generating circuit 330 and transmitted to the touch sensing device 140. The touch sensing device 140 may supply the first auxiliary signal SAUXT to a surrounding touch electrode of the touch electrode TE to which the touch driving signal STX is supplied for the touch sensing period TS.

Furthermore, for example, the second auxiliary signal SAUXD may be generated by the signal generating circuit 330 and transmitted to the data driving device 120. The data driving device 120 may supply the second auxiliary signal SAUXD to the data line DL for the touch sensing period TS.

Furthermore, for example, the third auxiliary signal SAUXG may be generated by the signal generating circuit 330 and transmitted to the gate driving device 130. The gate driving device 130 may supply the third auxiliary signal SAUXG to the gate line GL for the touch sensing period TS.

FIG. 14 is a diagram illustrating a method of operating the touch display device illustrated in FIG. 1.

Referring to FIG. 14, the method of operating the touch display device 100 may include generating a touch driving signal STX, that is, a signal in which the pulses of at least two frequencies alternate (S1410). In this case, the touch driving signal generation (S1410) may be performed by the signal generating circuit 330 included in the touch display device 100.

Furthermore, the method of operating the touch display device 100 may include supplying the touch driving signal STX to the touch electrode TE disposed in the panel 110 for one touch sensing period TS (S1420). In this case, the touch driving signal supply (S1420) may be performed by the driving circuit 310 included in the touch sensing device 140.

Furthermore, the method of operating the touch display device 100 may include sensing the touch or proximity of the external object for the panel 110 in response to a touch response signal SRX that is formed in the touch electrode TE in accordance with the touch driving signal STX (S1430). In this case, the touch sensing (S1430) may be performed by the sensing circuit 320 included in the touch sensing device 140.

The method of operating the touch display device 100 may further include generating an auxiliary signal SAUX that corresponds to the touch driving signal STX and that is changed in synchronization with the frequency of the touch driving signal STX. In this case, the auxiliary signal generation may be performed by the signal generating circuit 330 included in the touch display device 100.

Furthermore, the method of operating the touch display device 100 may further include supplying the auxiliary signal SAUX to at least one of multiple electrodes disposed in the panel 110 except the touch electrode TE to which the touch driving signal STX is supplied for the one touch sensing period TS. In this case, the auxiliary signal supply may be performed by one or more of the data driving device 120, the gate driving device 130 or the touch sensing device 140.

According to the aforementioned embodiments, the density of a frequency spectrum in the area of the touch driving signal STX is reduced through the touch driving signal STX, that is, a signal in which the pulses of at least two frequencies alternate. Accordingly, there can be provided the touch sensing device that reduces EMI, the touch display device including the touch sensing device, and the method of operating the touch display device.

What is claimed is:

1. A touch sensing device comprising:
a driving circuit configured to supply a touch driving signal to a touch electrode disposed in a panel; and
a sensing circuit configured to sense a touch or proximity of an external object to the panel based on a touch response signal that is formed in the touch electrode in response to the touch driving signal,
wherein the touch driving signal, supplied for a one touch sensing period in which a touch synchronization signal maintains a first level, comprises a signal in which pulses of different frequencies alternate.

2. The touch sensing device of claim 1, wherein the touch driving signal is a signal in which a pulse of a first frequency and a pulse of a second frequency alternate in a first period and is a signal in which a pulse of a third frequency and a pulse of a fourth frequency alternate in a second period different from the first period.

3. The touch sensing device of claim 2, wherein the first period and the second period are included in the one touch sensing period.

4. The touch sensing device of claim 2, wherein:
the first period is included in a first touch sensing period, and
the second period is included in a second touch sensing period different from the first touch sensing period.

5. The touch sensing device of claim 1, further comprising a multiplexer (MUX) circuit configured to output the touch driving signal selectively to at least one of multiple output terminals,
wherein the MUX circuit outputs the touch driving signal to one output terminal for the one touch sensing period.

6. The touch sensing device of claim 1, further comprising a multiplexer (MUX) circuit configured to output the touch driving signal selectively to at least one of multiple output terminals,
wherein the MUX circuit outputs the touch driving signal to at least two output terminals for the one touch sensing period.

7. The touch sensing device of claim 6, wherein:
the touch driving signal, which is output to a first output terminal among the at least two output terminals for the one touch sensing period, comprises a signal in which a pulse of a first frequency and a pulse of a second frequency alternate, and
the touch driving signal, which is output to a second output terminal among the at least two output terminals, comprises a signal in which a pulse of a third frequency and a pulse of a fourth frequency alternate.

8. The touch sensing device of claim 1, wherein the driving circuit receives the touch driving signal generated by a signal generating circuit configured to generate an auxiliary signal to be supplied to one or more electrodes disposed in the panel.

9. A device for driving a touch display, comprising:
a data driving device configured to drive pixels disposed in a panel for a display period in which a touch synchronization signal maintains a second level; and
a touch sensing device configured to supply a touch driving signal to at least one of multiple touch electrodes disposed in the panel for a touch sensing period, in which the touch synchronization signal maintains a first level, and to sense a touch or proximity of an external object to the panel based on a touch response signal that is formed in a touch electrode in response to the touch driving signal,
wherein the touch driving signal, supplied for one touch sensing period, comprises a signal in which pulses of different frequencies alternate.

10. The device of claim 9, wherein:
the touch driving signal is a signal in which a pulse of a first frequency and a pulse of a second frequency alternate for a first period of the one touch sensing period and a signal in which a pulse of a third frequency and a pulse of a fourth frequency alternate for a second period of the one touch sensing period, which is different from the first period,
wherein the first frequency and the second frequency are different from each other and the third frequency and the fourth frequency are different from each other.

11. The device of claim 9, wherein:
the touch driving signal is a signal in which a pulse of a first frequency and a pulse of a second frequency alternate for a first period included in a first touch sensing period and a signal in which a pulse of a third frequency and a pulse of a fourth frequency alternate for a second period included in a second touch sensing period, which is different from the first touch sensing period, wherein the first frequency and the third frequency are different from each other.

12. The device of claim 9, wherein the touch sensing device generates the touch driving signal and an auxiliary signal corresponding to the touch driving signal.

13. The device of claim 12, wherein a frequency of the auxiliary signal is changed in synchronization with a frequency of the touch driving signal.

14. The device of claim 13, wherein the auxiliary signal is supplied to at least one of the multiple electrodes disposed in the panel, excluding the touch electrode to which the touch driving signal is supplied for the one touch sensing period.

15. A method of operating a touch display device, comprising:
generating a touch driving signal comprising a signal in which pulses of at least two frequencies alternatively appear;
supplying the touch driving signal to a touch electrode disposed in a panel for one touch sensing period; and
sensing a touch or proximity of an external object to the panel based on a touch response signal that is formed in a touch electrode in response to the touch driving signal.

16. The method of claim 15, further comprising:
generating an auxiliary signal which corresponds to the touch driving signal and which is changed in synchronization with a frequency of the touch driving signal; and
supplying the auxiliary signal to at least one of multiple electrodes disposed in the panel, excluding the touch electrode to which the touch driving signal is supplied for the one touch sensing period.
